(19) United States
(12) Patent Application Publication
(10) Pub. No.: US 2003/0095051 A1
(43) Pub. Date: May 22, 2003

(54) Safelight

(76) Inventor: Eric William Urbano, Scotch Plains, NJ (US)

Correspondence Address: ERIC W. URBANO, P.O. BOX 276, SCOTCH PLAINS, NJ, 07076, US

(21) Appl. No.: 09/988,096

(22) Filed: Nov. 19, 2001

(51) Int. Cl. G08G 1/07

(52) U.S. Cl. 340/906; 340/902

(57) ABSTRACT

The SafeLight is comprised of a photo eye that emanates a signal that is received by a photo eye placed to receive the aforementioned signal, thereby altering the targeted traffic light accordingly. The signal is sent by pressing a button on the handheld or mounted apparatus manually or the signal is sent via an automatic setting. The handheld or mounted device may be placed on a simple mounting bracket to be placed in a convenient location in an emergency or official vehicle.

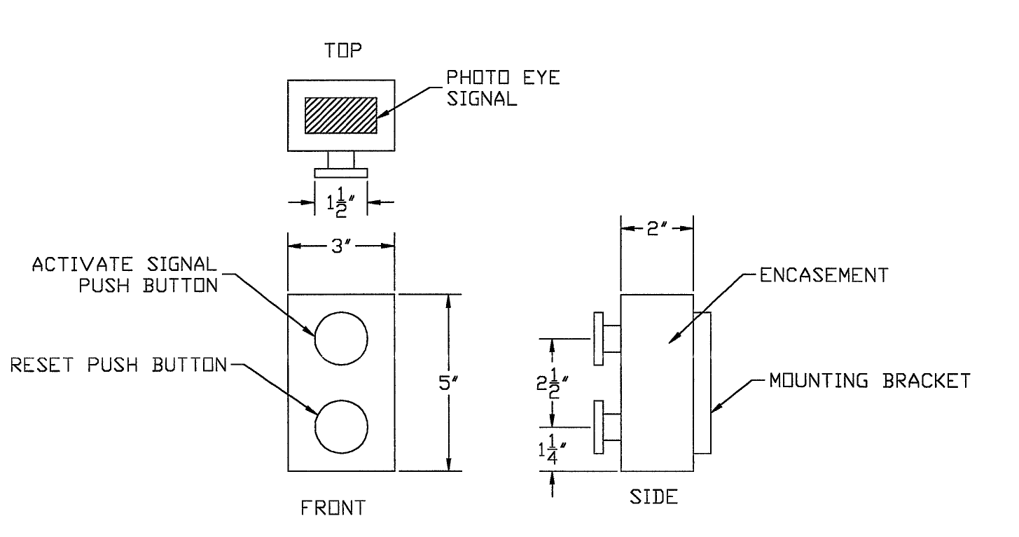

### CROSS REFERENCE TO RELATED APPLICATIONS

Not applicable.

### STATEMENT REGARDING FEDERALLY SPONSORED RESEARCH OR

DEVELOPMENT:

Not applicable.

### REFERENCE TO A MICROFICHE APPENDIX

Not applicable.

### BACKGROUND OF THE INVENTION

The SafeLight pertains to the field of public safety for use by the public sector and authorized members of the private sector.

### BRIEF SUMMARY OF THE INVENTION

The SafeLight provides emergency vehicle operators the means to alter a traffic light to alert other drivers and pedestrians of oncoming emergency vehicles. The immediate purpose of the SafeLight is to provide for the safety of all motorists and pedestrians in and around emergency and government vehicles being used for official or public safety objectives.

### DETAILED DESCRIPTION OF THE INVENTION

The SafeLight is designed to change the signal of a traffic light to display a predetermined signal that differs from normal traffic light signal patterns. The SafeLight emits a signal that activates an alternative signal pattern in a traffic light. A person using the SafeLight will use a mounted or hand-held device (shown in the technical drawing enclosed with this application) to emanate a frequency that will change the signal of the traffic light which the SafeLight user seeks to alter. SafeLight is designed to emit such frequency either manually (via the user physically using the push button apparatus as either a hand-held or mounted device to change the traffic signal) or automatically, whereby the hand-held or mounted push button apparatus may be set/programmed to automatically alter the signal of the desired traffic light upon the hand-held or mounted device once coming within the proximity of the desired traffic light.

A receiving/detecting component will be implanted in a/several traffic light(s) as part of The SafeLight product design. Once the user of the SafeLight hand-held or mounted apparatus activates the frequency to change the traffic light signal, the desired traffic light will emanate a signal different from standard, recognized traffic signals (such as solid red, yellow, green, or only one color flashing, such as blinking red, yellow or green). The traffic signal will display a signal pattern that will be distinct to the use of The SafeLight hand-held or mounted apparatus. This distinct traffic signal pattern will alert drivers, pedestrians (or any other classification of individuals or entities utilizing the streets, sidewalks, bike paths, walkways, railroad crossings, bridges, causeways or any other means of ground travel) that an authorized individual(s) is/are utilizing The SafeLight for a specified purpose, with the objective of clearing or freeing the desired intersection for use by authorized government personnel or authorized persons acting pursuant to an emergency or other authorized purpose.

Among the several uses for which The SafeLight may be used, The SafeLight may be used by emergency workers and emergency vehicles/police or government vehicle operators to alter traffic signals in and around their travel path to alert all others in the vicinity of approaching vehicles being utilized for emergency or official purposes. Among the purposes for which The SafeLight is designed to be implemented as stated above, The SafeLight is intended to increase public and private safety of all individuals and preservation of property in and around emergency vehicles being utilized for emergency or official purposes. The SafeLight is also intended to secure property from damage that may result from non-emergency individuals operating vehicles or machinery in and around the path of emergency vehicles while they are in operation. The SafeLight is also intended to increase traffic flow in and around emergency vehicles, thereby increasing the efficiency and effectiveness of emergency personnel and vehicles responding to, and involved in, emergency situations. This is not an exhaustive list of the uses for which The SafeLight may be utilized. Further, this is not an exhaustive list of the reasons for which The SafeLight may be used or implemented. In addition, this is not an exhaustive list of the effects The SafeLight may be used to effectuate.

### BRIEF DESCRIPTION OF THE DRAWING

The drawing submitted with this patent application provides the proposed size and specific design of The SafeLight and the activation apparati. The Photo Eye Signal is the device that will emanate the signal to alter the traffic signal pattern. The Photo Eye is also representative of a remote photo eye device that would be installed so as to receive the signal from The SafeLight and alter the desired traffic signal accordingly. The Push Button shows how the The SafeLight may be activated manually to emanate the signal. The Reset Push Button is shown in the drawing as a means to re-set the affected traffic signal to return to its standard light sequence. The Encasement provides a physical representation of the signal device itself, which is used to effectuate the desired light sequence. The Mounting Bracket as depicted demonstrates how The SafeLight activation device can be mounted in an emergency or official vehicle.

1. What I claim as my invention is:
the light display options, as triggered by the SafeLight design and utility described above and herein;
the concept design of the SafeLight such that a traffic light may be activated to display a pre-determined light sequence that indicates emergency or official vehicles are approaching that particular intersection or are being utilized for emergency or official purposes.
